(19) United States
(12) Patent Application Publication
(10) Pub. No.: US 2006/0125243 A1
(43) Pub. Date: Jun. 15, 2006

(54) Mechanism for rotating the rotor/s, stator/s, an electric power generator/s

(76) Inventor: Kobi Miller, Kiryat Ata (IL)

Correspondence Address: DANIEL J SWIRSKY, 55 REUVEN ST., BEIT SHEMESH, 99544, IL

(21) Appl. No.: 10/529,900

(22) PCT Filed: Sep. 29, 2003
(86) PCT No.: PCT/IL03/00779

§ 371 Date: Oct. 11, 2005

(30) Foreign Application Priority Data
Oct. 3, 2002 (IL) 152090

(51) Int. Cl. F03D 9/00; H02P 9/04

(52) U.S. Cl. 290/55

(57) ABSTRACT

Normal existing system generate electrical power from mechanical rotational power produced by internal combustion engines the rotors of the wind, which rotates the rotor in one direction, the stator being static and fixed. The device described makes the rotor and the stator in electric generators to rotate in opposite directions so as to generate more electrical power. With the aid of this device it is possible to generate more electrical power by using an internal combustion engine from the force of wind in a “wind turbine”, “gas turbine” and “hydroelectric power station” etc.

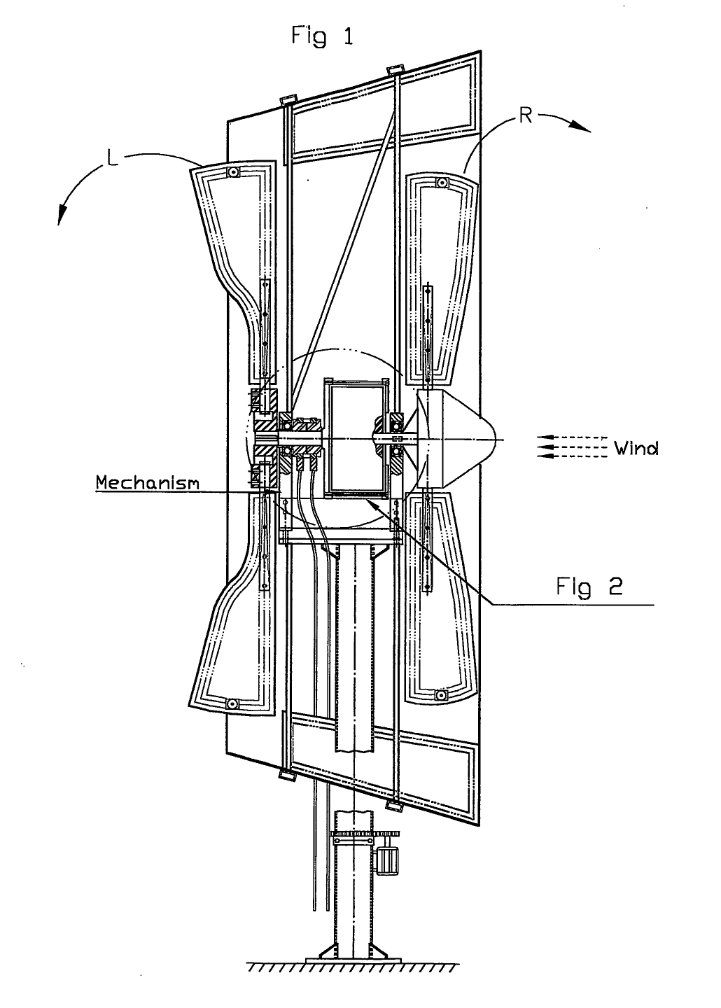

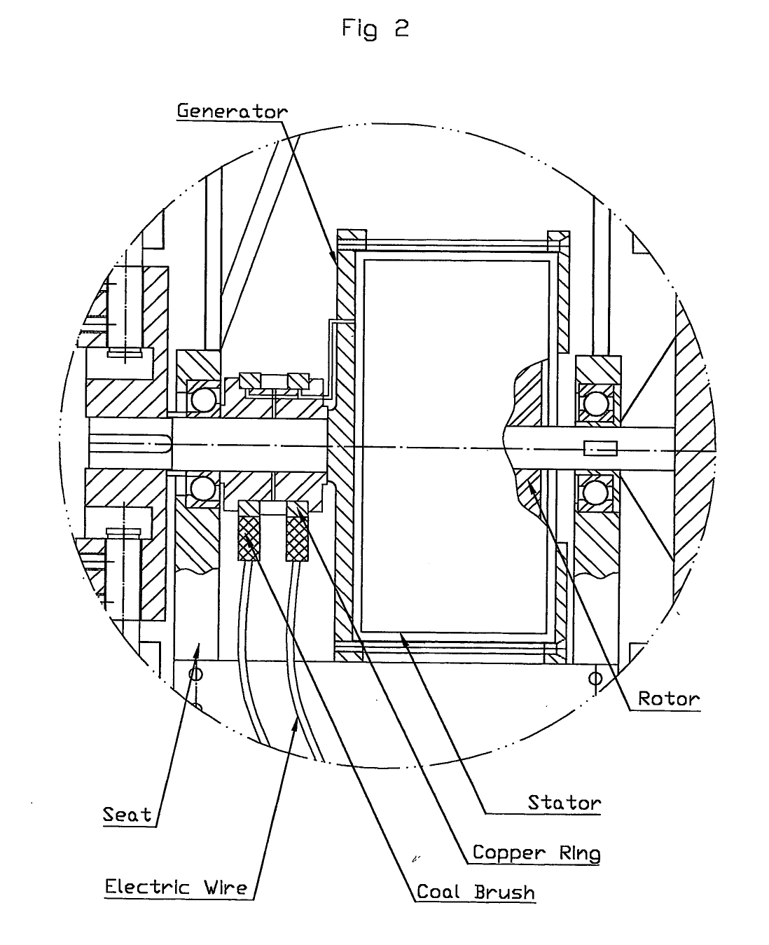

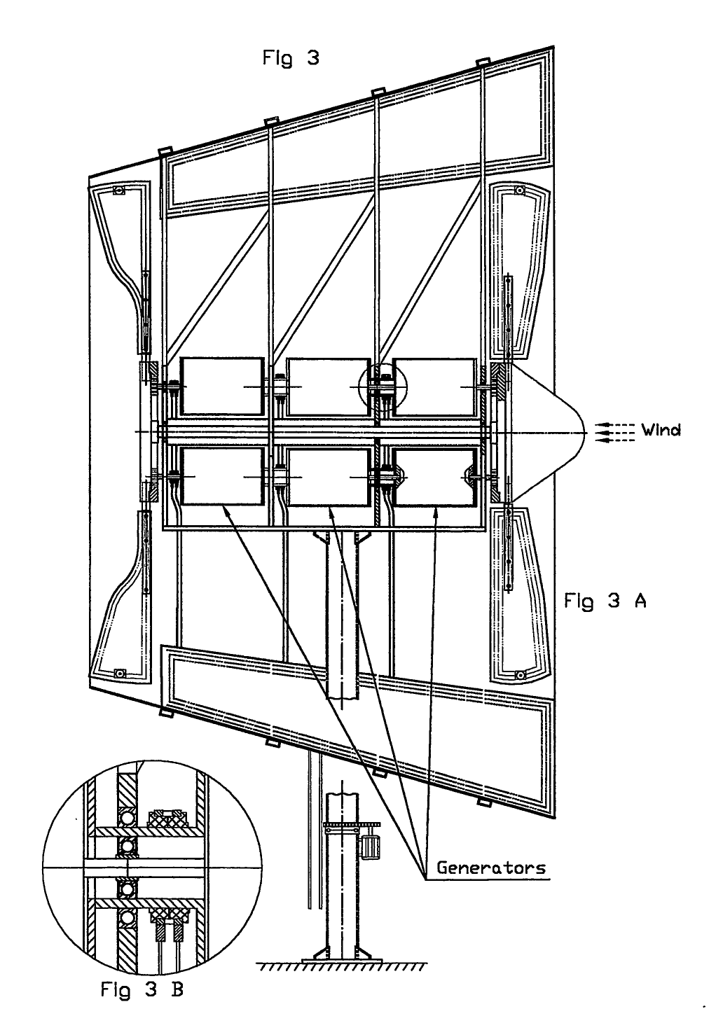

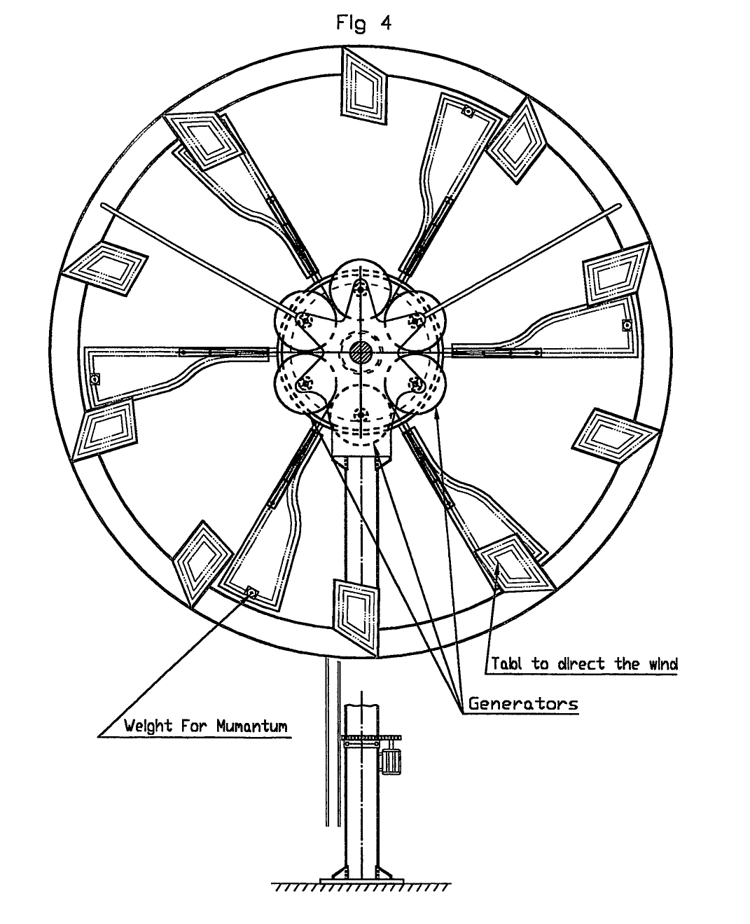

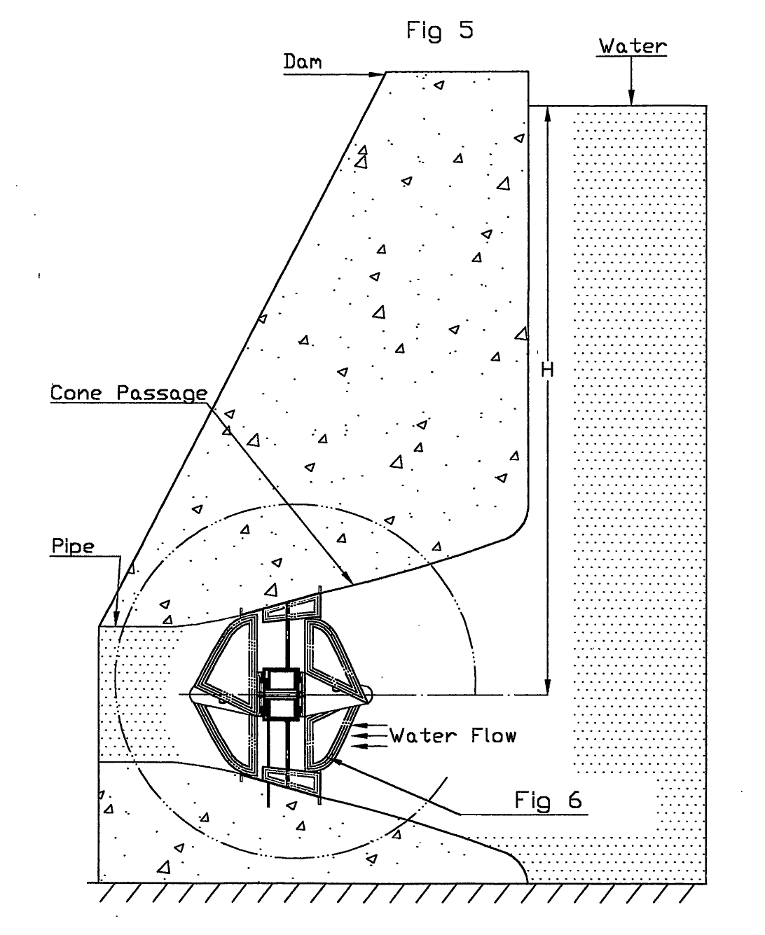

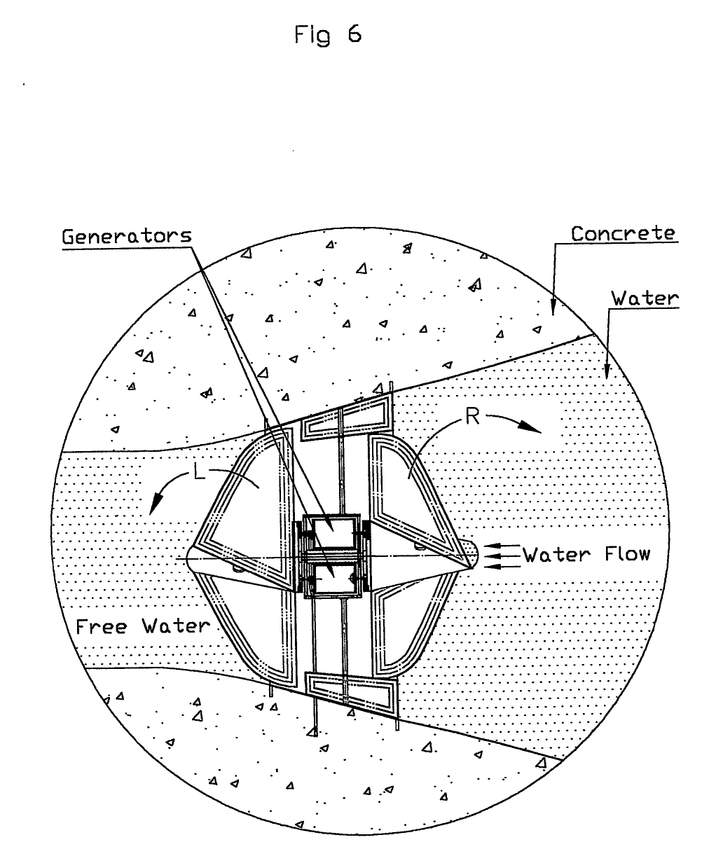

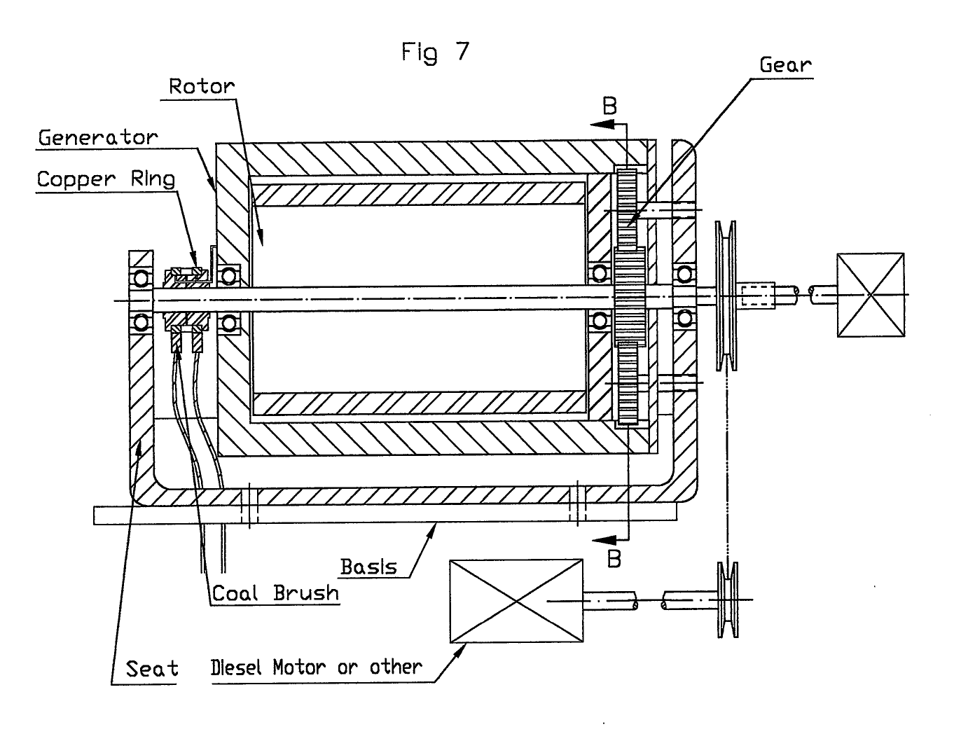

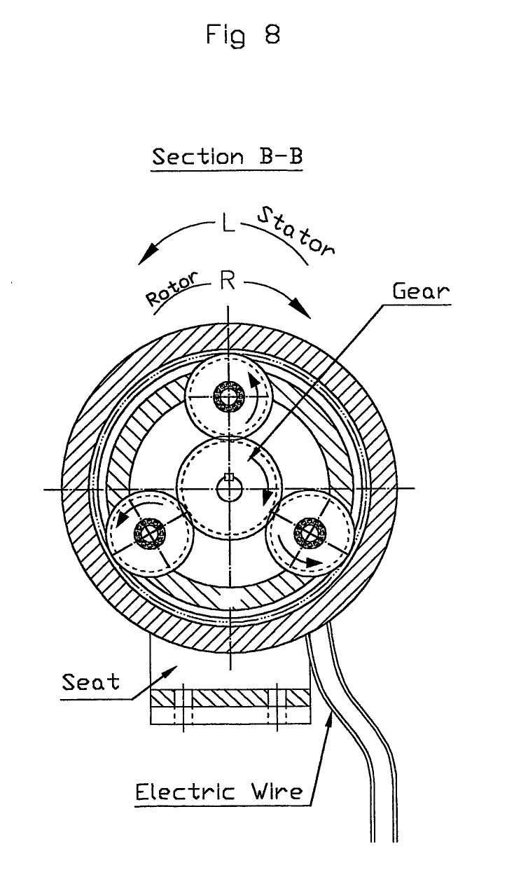

### THE TECHNICAL RANGE

The technical range of the device is a mechanical system into which an electrical element is integrated which is driven by a kinetic potential and by another external rotational force, the principle of operation of the system being rotation of the rotor and of the stator in electrical power generators in opposite directions in order to generate more electrical energy than in normal system that existed prior to the present invention.

### Prior Art

### BACKGROUND

Generators exist which are run by internal combustion engines (or any other source of rotational power), wind, water flow from a dam, gas jet etc., defined as “Wind Turbine” , “Gas Turbine” and “Hydroelectric Power Station” etc.

In Internal Combustion Engine (or any other source of rotational power) connected to the generator

Normal existing systems generate electrical power from mechanical rotational power produced by internal combustion engines the force of the wind, (or any other source of rotational power) which rotates the rotor in one direction, the stator being static and fixed.

In a “Wind Turbine” “Gas Turbine” and “Hydroelectric Power Stations”

The normal existing systems generate electrical power from the power of the wind, and/or the flow of water as in a dam and/or a jet of gas as in power stations. In wind turbines only one propeller turns and drives the rotor in the generator in one direction and the stator is fixed. The same with gas turbines and hydroelectric power stations.

### DESCRIPTION OF THE INVENTION:

The device described makes the rotor and the stator in electric generators to rotate in opposite directions so as to generate more electrical power. The device is made up of a range of connected parts (directly or by means of gears, pulleys etc.) in a particular systematic manner and constitutes a complete bi-directional system which performs an operation which produces more electrical energy than other normal known systems. The operation of the system causes rotation in opposite directions of the rotating assemblies and the electricity supply system as described in drawings 1 to 8, including, and the principle of operation can be seen.

The generator is an assembly of parts for the production of electrical energy or a machine for the conversion of mechanical energy to electrical current [direct current—DC or alternating current—AC] when the rotor of the generator rotates inside the stator of the generator.

The rotor is an internal mechanical part of the generator, which rotates in a certain direction and constitutes a complementary component for the stator in the generator in order to generate electrical energy from rotational mechanical energy.

The stator is another mechanical part which covers the rotor in the generator and is a complementary part for the action in order to generate electrical energy from rotational mechanical energy.

The propeller(s) are blades rotating on a shaft in order to extract motive power from wind and/or water and/or gasses in order to create rotational mechanical power. The propeller(s) are made up of various parts and diverse materials.

With the aid of said device it is possible to generate more electrical power by using an internal combustion engine (or any other rotational power source), from the force of wind in a “wind turbine” , “gas turbine” and “hydroelectric power station” etc.

The device in combination with an internal combustion engine (or any other source of rotational force)

The above mentioned device, coupled to an internal combustion engine (or any other source of rotational force), in direct drive or coupled to a gear system and/or belt drive and or a planetary transmission or other system, will cause the rotor and the stator to revolve in opposite directions with the generator connected to a base with bearings will generate more electrical power energy, i.e., at a certain productive speed it will be possible to generate more electrical power energy at a steady speed when compared to a normal generator the stator of which is fixed and not moving. The above mentioned device can operate a large number of generators; the device also includes a system for delivery of the electrical current generated in the generator(s).

The device coupled to a “wind turbine”, “gas turbine”, “hydroelectric power station”

When the device is coupled to a “wind turbine”, “gas turbine”, “hydroelectric force propeller” will generate more electrical power energy from the wind force and/or gas jet and/or water flow as existing in a dam, the above mentioned forces create power by one and/or two propellers and/or screws and/or wheels moved by the pressure force of gasses, the principle being creation of counter-rotation between rotor and stator of the generator which is mounted on a frame with bearings, the counter-rotation of stator and rotor creates higher relative speeds, enabling higher output of electrical power energy. The device can also generate electrical power energy with a large number of generators. The system also includes means for delivering the generated electricity.

### DESCRIPTION OF THE DRAWINGS:

Drawing No. 1—The complete device which turns the rotor and the stator of the electrical power generator using wind force in opposite directions used to generate electrical power energy.

Drawing No. 2—Area of the center of the device described in Drawing No. 1 showing a generator connected to a base with bearings enabling rotor and stator to counter-rotate and generate electrical power energy which is transmitted through an additional system with copper rings, carbon brushes and electrical wires and/or other means.

Drawing No. 3—A complete device which rotates several electrical power generators counter-rotating using existing wind power on a central shaft and horizontally used to generate electrical power energy.

Drawing No. 4—Frontal view of a device which rotates several electrical power generators counter-rotating using existing wind power on a central shaft used to generate electrical power energy.

Drawing No. 5—A device which rotates several generators on a central shaft in which the rotor(s) and the stator(s) counter-rotate used for the production of electrical power energy from the force of a jet and/or flow of water such as water flowing from a dam.

Drawing No. 6—Area of the center of the device described in Drawing No. 5 showing a number of generators connected around a central shaft in a base with bearings enabling rotor(s) and stator(s) to counter-rotate and generate electrical power energy which is transmitted through an additional system with copper rings, carbon brushes and electrical wires and/or other means.

Drawing No. 7—A device connected to an internal combustion engine or to any other source of rotational power, which is assembled with a gear transmission and/or belt transmission, in a planetary system or similar which causes the rotor and stator to rotate in opposite directions when the generator is connected to a frame with bearings and a base, so that at a given production speed more electrical power energy can be generated.

Drawing No. 8—Section BB of drawing No. 7 showing the generator connected to a frame equipped with bearings which enables the rotor and the stator to rotate in opposite directions by means of a gear transmission where the driving force is an internal combustion engine or any other source of rotational force.

### THE PREFERRED WAY FOR EXECUTING THE INVENTION:

In order to establish a real argument a prototype was constructed, identical to drawings 1 and 2 in order to verify that the above mentioned device is practical, the device was tested by an expert (PhD in the relevant profession), an opinion of the expert exists in the words “combined work of both rotors (propellers) almost double the voltage and therefore should also double the output of the turbine”. In drawings 3 and 4 the principle is identical but with a large number of generators.

The same holds for hydroelectric power plants where the force of the water stream as existing in dam(s) creates the action of counter-rotation of stator(s) and rotor(s) of the electric generators (where the variable is the material density) as described in drawings 5 and 6.

Combining the device with a driving force such as an internal combustion engine or any other source of rotational force as described in drawings 7 and 8, where the device is directly connected or via a gear transmission and/or belt and/or planetary and/or a similar method, will cause the rotor(s) and stator(s) of the electric generators to rotate in opposite directions, i.e., when the electric power generators are connected to a frame with bearings and a base in order to generate more electrical power energy, i.e., at a given productive rotation speed of an internal combustion engine or any source of rotational force which rotates at a constant speed it is possible to generate more electrical power energy when the device is integrated in it, when compared to a normal generator with a fixed stator, also the above mentioned device is able to generate electrical power energy with a large number of generators, so that it may be concluded that integrating the device with an internal combustion engine and similar will result in saving fuel.

The way to implement the invention in industry and the suitable production or use of the invention:

In the world there are wind turbines, gas turbines, hydroelectric power plants, and all kinds of power plants, generators or any generator generating electrical power energy, before the invention only the rotor rotates and the stator is static and fixed.

Implementation of the invention is possible when the above mentioned device will be integrated with the generator(s) and/or alternators and/or dynamos, in order to almost double the output of electrical power energy produced because the stator(s) and the rotor(s) rotate in opposite directions and the relative speed between them double the voltage and therefore will also double the above mentioned generator output which exist in diverse applications. Using this technology it is possible to upgrade the existing wind turbines in the world and to double their output. The same is true for any generator existing in the world.

Integration of the device with an internal combustion engine or any source of rotational force operated by fuel, will save about half the fuel used to operate the generator and provided that the device will be integrated in it.

1. Protecting the invention will be based on the principle of the proposed device which causes the generator(s) to rotate the rotor(s) and the stator(s) in opposite directions in order to generate more electrical power energy than conventional generators.

2. Protection of the invention will be based on the principle of the method of the device which comprises many parts and diverse materials, in a certain methodology and constitutes a whole system which makes the rotor(s) and stator(s) in generator(s) counter-rotate, in this way performing an operation necessary in order to generate electrical power energy which is different from normal presently existing conventional systems and produce more electrical power energy.

3. Protection of the invention will be based on the principle and mode of operation by means of the above mentioned device when the driving force is wind force, water force from a dam, a gas jet, an internal combustion engine or any source of rotational force whether by using fuel and/or other means and provided that the devil will be integrated creating counter-rotation of the rotor(s) and stator(s) in the electric power generator(s) and more electric power energy will be produced.

4-5. (canceled)
